(19) United States
(12) Patent Application Publication
(10) Pub. No.: US 2009/0017390 A1
(43) Pub. Date: Jan. 15, 2009

(54) EXTERNAL TONER ADDITIVE, TONER AND IMAGE FORMING APPARATUS USING THE SAME

(76) Inventors: Akiko Tsuji, Kameyama-shi (JP); Tohiaki Ino, Soraku-gun (JP); Yasuhiro Nishimura, Takaishi-shi (JP)

Correspondence Address: NIXON & VANDERHYE, PC, 901 NORTH GLEBE ROAD, 11TH FLOOR, ARLINGTON, VA, 22203, US

(21) Appl. No.: 12/135,491

(22) Filed: Jun. 9, 2008

(30) Foreign Application Priority Data
Jul. 9, 2007 (JP) 2007-180206

(51) Int. Cl. G03G 9/08; G03G 15/00

(52) U.S. Cl. 430/108.3; 399/222

(57) ABSTRACT

To provide a toner and an image forming apparatus using the toner, the toner contains an external additive that can suppress adherence of impurities to a discharge electrode of a corona discharger and prevent occurrence of charging unevenness. The external toner additive is comprised of a particulate metal oxide with trimethylsilyl groups introduced on the surface thereof, the volatile amount of trimethylsilanol being specified to be 0.25 μg or below based on a method for quantitative analysis of trimethylsilanol in the external additive. The toner of the present invention is specified such that the volatile amount of trimethylsilanol is specified to be 0.02 μg or below based on a method for quantitative analysis of trimethylsilanol in the toner.

This Nonprovisional application claims priority under 35U.S.C. §119(a) on Patent Application No. 2007-180206filed in Japan on 9 Jul. 2007, the entire contents of which are hereby incorporated by reference.

### BACKGROUND OF THE INVENTION

(1) Field of the Invention

The present invention relates to an external toner additive, toner using it and an image forming apparatus such as a copier, printer, facsimile machine and the like, having a printing function using the toner based on electrophotography.

(2) Description of the Prior Art

An image forming apparatus using static electrophotography typically includes the steps of charging, exposure, development, transfer, separation, cleaning, charge erasing and fixing. The step forming an image is effected by uniformly charging the surface of a rotationally driven photoreceptor drum, for example, with a charging device and then illuminating the charged photoreceptor drum with a laser beam to form an electrostatic latent image. This electrostatic latent image on the photoreceptor drum is developed by electrostatically adhering toner to form a toner image on the photoreceptor drum surface. The toner image on photoreceptor drum is transferred to a transfer medium by a transfer device, so that the toner image on this transfer medium is fixed by a thermal fusing device. Residual toner on the photoreceptor drum surface after transfer is removed by a cleaning device and collected into a predetermined collecting portion while residual charge is removed off the photoreceptor drum surface after cleaning to prepare for subsequent image forming.

As the photoreceptor drum, a photoreceptor drum having an organic photoconductor (OPC) applied thereon as an optical conductive layer is usually used. As the charging device for applying electricity on the photoreceptor drum surface a corona charger is widely used.

A corona charger is formed of an extremely thin conductive tungsten wire, to which a high voltage is applied to thereby cause corona discharge and electrify the photoreceptor drum, and a conductive shield case that encloses the wire over the sides other than the side that opposes the photoreceptor drum. Instead of tungsten wire for corona discharge, a saw-toothed discharge electrode having a large number of pointed projections in a row may be provided so as to cause corona discharge from the pointed projections to perform charging over the photoreceptor drum. Corona chargers are also used as a charge erasing device, transfer device and the like other than the purpose of photoreceptor drum charging.

In such corona chargers, if some dirt adheres to the tungsten wire, saw-toothed discharge electrode and the like, the discharge performance degrades at that portion, so that it becomes impossible to uniformly electrify the photoreceptor drum. If such charging unevenness occurs, image defects such as a black stripe and other defect occurs in the resultant image.

A prior art technology for solving the problem of dirt on needle-like electrodes, as above, has been disclosed in patent document 1 (Japanese Patent Application Laid-open Hei 7-43990) for example. According to the disclosed technology of patent document 1, a cleaning assembly is formed of a pair of rotationally supported rollers so that a needle-like electrode is removed of dirt adhering thereon by moving the cleaning assembly relative to the needle-like electrode while holding the electrode between the paired rollers.

### SUMMARY OF THE INVENTION

Though the above countermeasure is very effective as a method for refreshing a needle-like electrode where the trouble of charging unevenness is occurring, it is not a method that can prevent dirt from adhering to the discharge electrode of the corona charger. That is, it was necessary to frequently clean the corona charger in order to constantly keep beneficial print quality.

In view of the above circumstances, it is therefore an object of the present invention to provide an external toner additive and toner using this external additive, which can prevent occurrence of charging unevenness by suppressing adherence of impurities that would adhere to the discharge electrode of a corona charger, and an image forming apparatus using this toner.

An external toner additive of the present invention comprises a particulate metal oxide with trimethylsilyl groups introduced on the surface thereof, the volatile amount of trimethylsilanol being specified to be 0.25 μg or below based on a method for quantitative analysis of trimethylsilanol in the external additive.

In accordance with the invention, use of the above external toner additive for the toner used in an image forming apparatus having a corona charger makes it possible to produce a toner which prevents occurrence of charging unevenness and assures stable images free from black stripes over a prolonged period of time.

Here, the method for quantitative analysis of trimethylsilanol in the external additive was achieved by loading 2.0 g of a particulate metal oxide into a closed container (50 L) heated at a temperature of 120 deg.C., stabilizing the temperature inside the container to be uniform, and then sampling the vaporized gas containing trimethylsilanol inside the closed container into a TENAX collecting tube (a product of GERSTEL Inc., GSL09947-00) with a vacuum suction pump (sampling pump SP204-50, manufactured by GL Sciences Inc.) with an integrating flowmeter connected on the suctioning side of the TENAX collecting tube.

As for the conditions for sampling the vaporized gas, the temperature inside the closed contained was kept at 120 deg.C. and 6 liter of air in the closed container was passed through the TENAX collecting tube at a rate of 0.2 liter per minute for30minutes. Analysis of the vaporized gas collected by the TENAX collecting tube was carried out by measuring the gas by setting the injection temperature in a gas chromatograph mass analyzer (6890/5973inert MSD, manufactured by Agilent technologies) and a thermal desorption system (TDS/C1S4 SYSTEM, manufactured by GERSTEL K.K) at 280 deg.C.

A toner of the present invention comprises: coloring resin particles; and an external additive adhered to the coloring resin particles, the external additive being formed of a particulate metal oxide with trimethylsilyl groups introduced on the surface thereof, the volatile amount of trimethylsilanol being specified to be 0.25 μg or below based on the method for quantitative analysis of trimethylsilanol in the external additive, and is characterized in that the volatile amount of trimethylsilanol is specified to be 0.02 μg or below based on a method for quantitative analysis of trimethylsilanol in the toner.

In accordance with the invention, use of the above toner in an image forming apparatus having a corona charger makes it possible to prevent occurrence of charging unevenness and assure stable images free from black stripes over a prolonged period of time.

Here, the method for quantitative analysis of trimethylsilanol in the toner was achieved by loading 10 g of toner into a closed container (50 L) heated at a temperature of 100 deg.C. using an aluminum plate, stabilizing the temperature inside the container to be uniform, and then sampling the vaporized gas containing trimethylsilanol inside the closed container into a TENAX collecting tube (a product of GERSTEL Inc., GSL09947-00) with a vacuum suction pump (sampling pump SP204-50, manufactured by GL Sciences Inc.) with an integrating flowmeter connected on the suctioning side of the TENAX collecting tube. As for the conditions for sampling the vaporized gas, the temperature inside the closed contained was kept at 120 deg.C. and 6 liter of air in the closed container was passed through the TENAX collecting tube at a rate of 0.2 liter per minute for 30 minutes.

Analysis of the vaporized gas collected by the TENAX collecting tube was carried out by measuring the gas by setting the injection temperature in a gas chromatograph mass analyzer (6890/5973inert MSD, manufactured by Agilent technologies) and a thermal desorption system (TDS/C1S4 SYSTEM,manufactured by GERSTEL K.K) at 280 deg.C.

The toner of the present invention may be specified such that the number mean diameter of the external additive ranges from 7 nm to 30 nm and the content of the external additive in the toner ranges from 0.5% by weight to 3% by weight.

According to the invention, it is possible to obtain a toner that is excellent in fluidity and static charge performance without degrading its fixability.

The toner of the present invention may be specified such that the metal oxide is a particulate silica having trimethylsilyl groups introduced on the surface thereof. According to the invention, since possession of particulate silica on the toner surface provides excellent insulation for the toner, it is possible to provide a toner free from lowering of static charge thereon, hence produce images without causing fogging and image density failures over a prolonged period of time.

The toner of the present invention may be specified such that the particulate metal oxide is a particulate silica having trimethylsilyl groups introduced on the surface thereof by hexamethyldisilazane.

In this invention, since the particulate metal oxide treated with hexamethyldisilazane is low in moisture absorbency and hence the toner containing it is free from lowering of static charge thereon under a high-humidity environment, it is possible to produce stable images without causing fogging and image density failures over a prolonged period of time.

The toner of the present invention may be specified such that the particulate silica is obtained by blowing hot dry air at a temperature of 110 deg.C. to 150 deg.C. for 30 or more minutes to the particulate silica that has trimethylsilyl groups introduced on the surface thereof by hexamethyldisilazane, at a rate of 0.1 m³ per minute for 100 g of the particulate silica.

In this invention, it is possible to prevent pollution of the discharge electrode of a corona charger, which can be considered to be attributed to volatile organic silicides other than trimethylsilanol that, to a high degree, adhere on the particulate silica surface.

Further, an image forming apparatus of the present invention is an image forming apparatus for forming images based on an electrophotographic process, comprising: a photoreceptor drum for forming an electrostatic latent image on the surface thereof; a corona charger for electrifying the photoreceptor drum surface; an exposure device for forming an electrostatic latent image on the photoreceptor drum surface; a developing unit for holding toner and supplying the toner to the electrostatic latent image on the photoreceptor drum surface to form a toner image; a transfer device for transferring the toner image on the photoreceptor drum surface to a recording medium; a cleaning unit for cleaning the photoreceptor drum surface; and, a fuser device for fixing the toner image to the recording medium.

In this invention, it is possible to provide an image forming apparatus which is unlikely to undergo charging unevenness and can produce stable images free from black stripes over a prolonged period of time.

Further, in the image forming apparatus of the present invention, the corona charger may be a saw-toothed charger. In this invention, it is possible to provide an environmentally friendly image forming apparatus which emits a lower amount of ozone gas and can produce stable images free from black stripes over a prolonged period of time.

Use of the external additive and toner of the present invention in an image forming apparatus having a corona charger makes it possible to prevent occurrence of charging unevenness, hence produce stable images free from black strips over a prolonged period of time.

### BRIEF DESCRIPTION OF THE DRAWINGS

FIG. 1 is a sectional view schematically showing a configuration of an image forming apparatus according to the present invention;

FIG. 2 is a sectional view schematically showing a configuration of a developing unit and a photoreceptor drum;

FIG. 3 is an exploded perspective view showing a configuration of a saw-toothed charger;

FIG. 4 is a block diagram showing one example of a power supply circuit including a high-voltage circuit for supplying voltage to a corona charger;

FIG. 5 is a SEM photographic chart of pointed ends of a discharge electrode of a corona charger free from buildups therein when a toner according to the present invention is used; and

FIG. 6 is a SEM photographic chart of pointed ends of a discharge electrode of a corona charger with buildups therein when a conventional toner is used.

### DESCRIPTION OF THE PREFERRED EMBODIMENTS

The embodiment of the present invention will hereinafter be described with reference to the accompanying drawings.

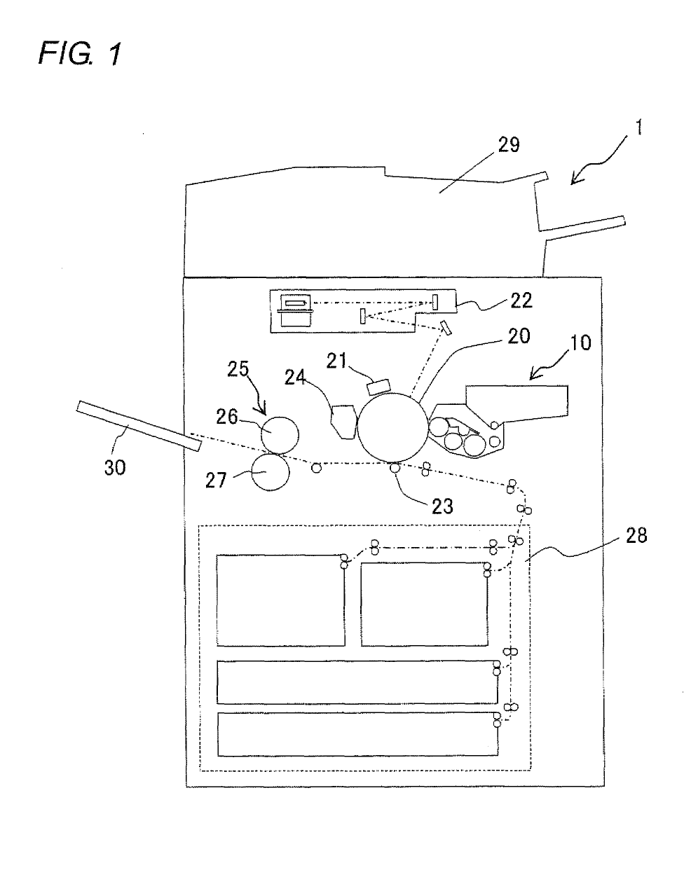

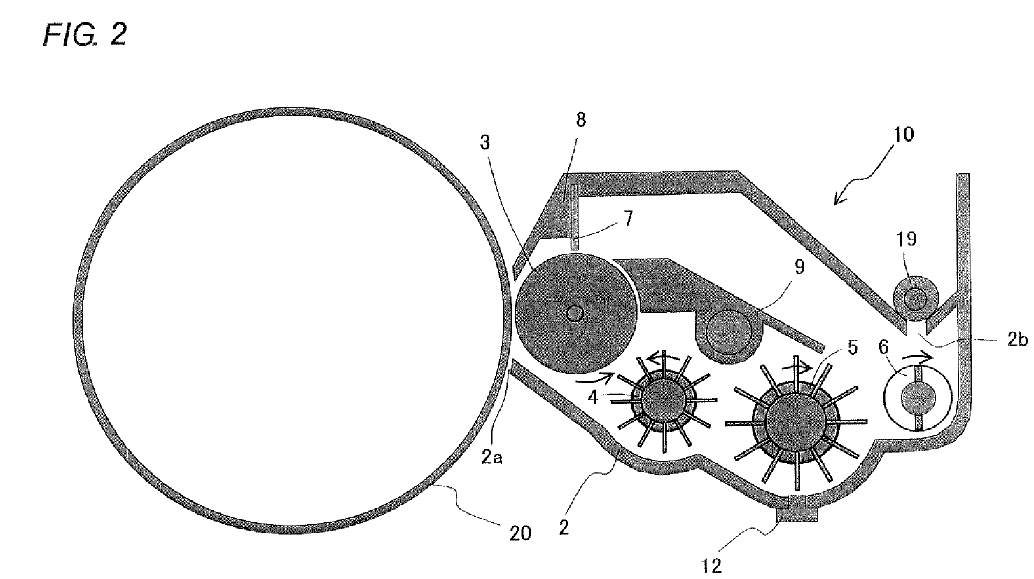

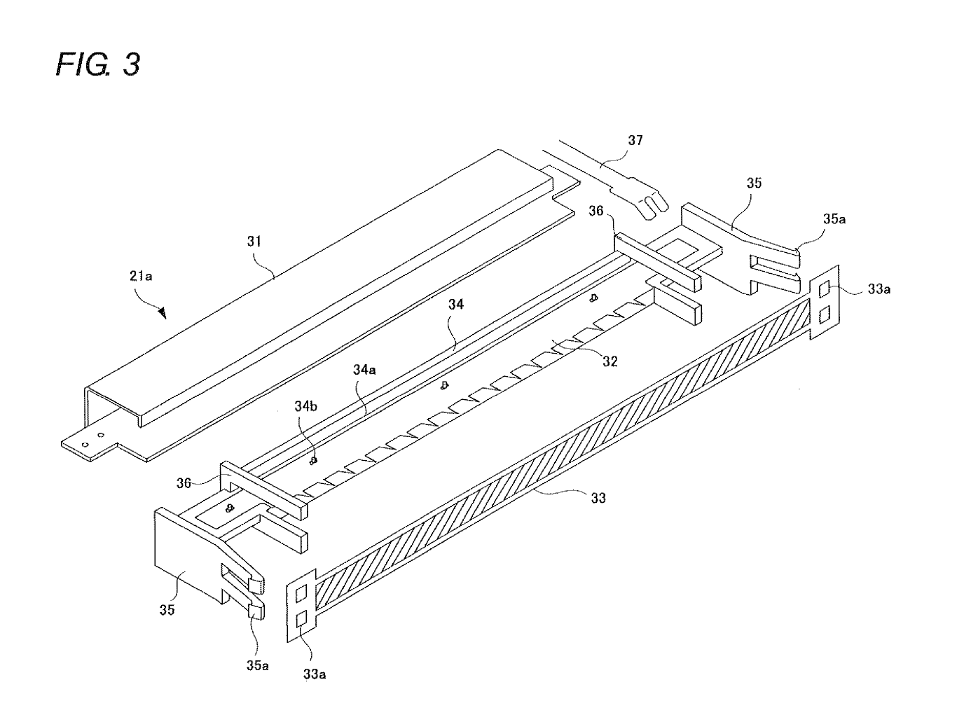

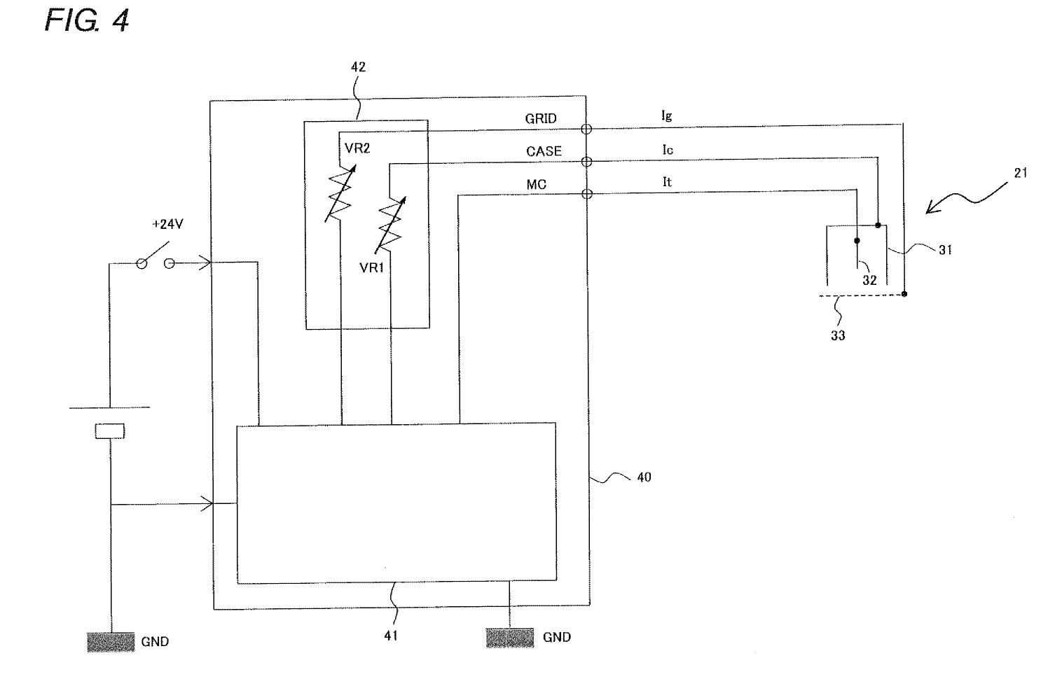

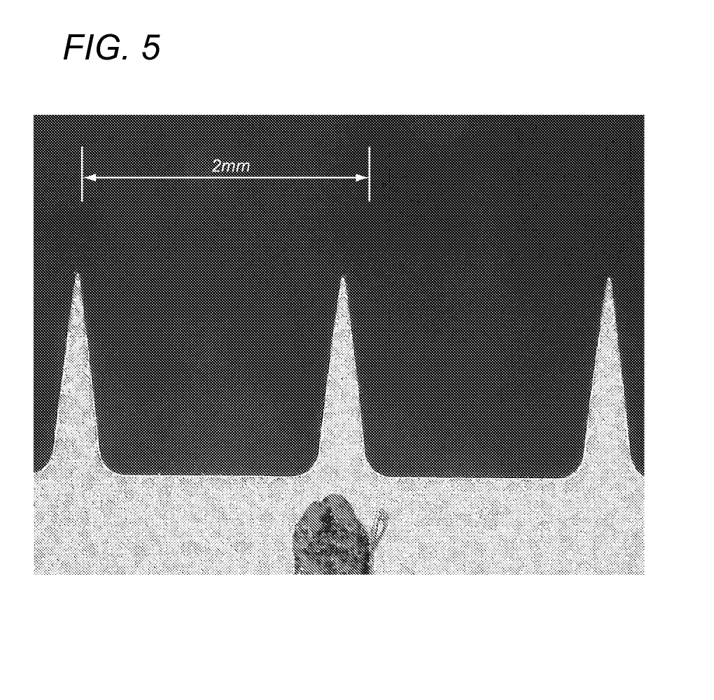

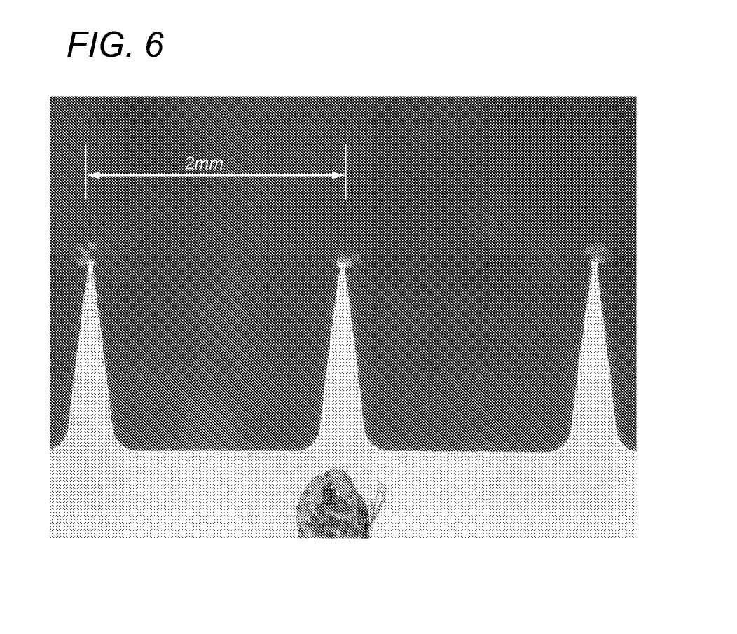

FIGS. 1 to 4 show one example of the embodiment of the present invention. FIG. 1 is a sectional view schematically showing a configuration of an image forming apparatus according to the present invention. FIG. 2 is a sectional view schematically showing a configuration of a developing unit and a photoreceptor drum. FIG. 3 is an exploded perspective view showing a configuration of a saw-toothed charger. FIG. 4 is a block diagram showing one example of a power supply circuit including a high-voltage circuit for supplying voltage to a corona charger. FIG. 5 is a SEM photographic chart of pointed ends of a discharge electrode of a corona charger free from buildups therein when a toner according to the present invention is used. FIG. 6 is a SEM photographic chart of pointed ends of a discharge electrode of a corona charger with buildups therein when a conventional toner is used.

The external toner additive of the present invention and the toner using it and image forming apparatus using the toner should not be limited to the following embodiment, but it goes without saying that various modifications can be added without departing the spirit and scope of the invention.

The external toner additive of the invention is a particulate metal oxide with trimethylsilyl groups introduced on the surface thereof, the volatile amount of trimethylsilanol being specified to be 0.25 μg or below based on the above-described measuring method.

If a toner containing an external toner additive of which the volatile amount of trimethylsilanol exceeds 0.25 μg is used in an image forming apparatus, impurities consisting of silica compounds build up in the discharge electrode of the corona charger. As a result, corona discharge becomes unstable so that it is impossible to uniformly charge the photoreceptor drum. That is, charging unevenness occurs, causing black stripes and other defects in resultant images.

The mechanism of how impurities build up on the discharge electrode has not been clearly understood, but can be guessed as follows.

Usually, particles of metal oxides such as particulate silica, titanium oxide and the like have a lot of hydroxyls on the surface thereof, hence they will have a large adsorption of water under high-humidity circumstances. As a result, if particulate metal oxide is externally added to a toner without any treatment, the amount of static charge on the toner under high-humidity circumstances lowers, causing fogging and other defects. In order to prevent this, the hydrophilic, hydroxyls that exist on the surface of metal oxide particles are subjected to a hydrophobic treatment using silane coupling agents.

When the hydroxyls on the surface of particulate metal oxide are converted into trimethylsilyl groups using hexamethyldisilazane and the like, trimethylsilanol forms during the reaction process (there is also a case in which trimethylsilanol is contained in the material of silane coupling agents), adheres and remains on the particulate metal oxide surface by formation of hydrogen bonds and the like. Since trimethylsilanol is a liquid having a boiling point of 98 to 99 deg.C. and being prone to vaporize, it is considered that if a toner containing this is used inside an image forming apparatus, trimethylsilanol gradually evaporates from the toner, and builds up on the discharge electrode of the corona charger. On the other hand, since, in the discharge electrode, corona discharge is caused to occur by application of high voltage during image forming, it is guessed that trimethylsilanol undergoes chemically change into non-volatile silicides, as a result of oxidation-reduction reactions due to the discharge voltage, which adhere to, and gradually buildup on, the discharge electrode. Accordingly, use of particulate metal oxide of which the volatile amount of trimethylsilanol is 0.25 μg or below as an external toner additive makes it possible to suppress impurities from adhering to the discharge electrode and hence prevent occurrence of charging unevenness.

A particulate metal oxide with trimethylsilyl groups introduced as hydrophobic groups on the surface thereof, being specified so that the volatile amount of trimethylsilanol is 0.25 μg or below can be produced by the following process, for example. That is, a particulate metal oxide with introduced trimethylsilyl groups on the surface thereof, which is produced in a publicly known method, is agitated while air of 100 to 200 deg.C. is being blown therein for 30 to 60 minutes using a mixer having a heating device so as to evaporate trimethylsilanol to thereby obtain the desired particulate metal oxide. Upon this, trimethylsilanol cannot be removed sufficiently if the amount of air to be blown in is too low though depending on the amount of the particulate metal oxide. So it is necessary to blow in a sufficient amount of air. The amount of air may be determined as appropriate so that the volatile amount of trimethylsilanol to be processed is equal to or lower than 0.25 μg. There is also a method in which heated air is circulated in combination with a condenser that is arranged in the air flow passage to collect trimethylsilanol.

As the metal oxide particles before trimethylsilanol is introduced to the surface, a particulate metal oxide having a number mean diameter of 5 to 50 nm with hydroxyls on the surface thereof may be used. For example, fumed silica, alumina, titania and co-oxidized metal thereof obtained by a high-temperature vapor phase hydrolysis process can be used.

Specifically, the following products can be mentioned: AEROSIL 50 (mean diameter: about 30 nm), AEROSIL 90 (mean diameter: about 30 nm), AEROSIL 130 (mean diameter: about 16 nm), AEROSIL 200 (mean diameter: about 12 nm), AEROSIL 300 (mean diameter: about 7 nm) and AEROSIL 380 (mean diameter: about 7 nm), manufactured by NIPPON AEROSIL CO., LTD., ALUMINUM OXIDE C (mean diameter: about 13 nm), TITANIUM OXIDE P-25 (mean diameter: about 21 nm) and MOX170 (mean diameter: about 15 nm) manufactured by West Germany Degussa Corporation.

In the aforementioned particulate metal oxides, fine particles with trimethylsilanols introduced by a silane coupling process present excellent insulation. As a result, toners using this as an external additive become hard to lower the amount of static charge and are hard to cause fogging and other similar defects, hence these particles can be used preferably as an external toner additive. Particulate silica and the like have many active hydroxyls on the surface thereof, so that they are prone to react with a silane coupling agent hence can easily introduce trimethylsilanols.

As the silane coupling agent used for introducing trimethylsilanols to the particulate metal oxide, hexamethyldisilazane, trimethylchlorosilane, trimethylsilanol and the like can be listed. The processing method with a silane coupling agent can be carried out by a publicly known method, for example, by spraying a silane coupling agent while a particulate metal oxide having hydroxyls on the surface thereof is being agitated, then heating the mixture.

In particular, a particulate metal oxide on the surface of which trimethylsilanols have been introduced using hexamethyldisilazane (which will be also referred to hereinbelow as HMDS) as the silane coupling agent, for example, a particulate silica, presents excellent hydrophobicity and insulation. Accordingly, the toner with this particulate externally added becomes stable in the amount of static electricity under high-humidity circumstances hence is unlikely to cause fogging and similar defects, so that it can be preferably used as an external toner additive.

Particularly, with the particulate silica on the surface of which trimethylsilanols have been introduced using hexamethyldisilazane, it is preferred that trimethylsilanol is removed from the silica by blowing hot dry air at a temperature of 110 deg.C. to 150 deg.C. for 30 or more minutes to the particulate silica at a rate of 0.1 m³ per minute for 100 g of the particulate silica. Use of the thus prepared particulate silica makes it possible to suppress adherence of impurities to the discharge electrode of the corona charger to a high degree.

The reason can be deduced as follows. That is, the particulate silica on the surface of which trimethylsilanols have been introduced using hexamethyldisilazane may be considered to contain various kinds of volatile organic silicides (having a boiling point of 99 deg.C. or higher) in addition to trimethylsilanol. Inside the image forming apparatus, the toner is fixed to the recording medium such as paper or the like by the fuser device. Since, in fixing, the toner is heated up to the temperature (110 deg.C. to 150 deg.C.) at which the toner melts, it is considered that volatile organic silicides having high boiling points that have adhered to the particulate silica surface will evaporate by the heat from the fuser device and adhere to the discharge electrode of the corona charger.

Next, the toner according to the present invention will be described.

When the content of the external toner additive is 0.3% by weight or below on the toner weight basis, improvement of toner fluidity cannot be obtained, while the fixing performance is prone to degrade when the content is 3% by weight or above. Accordingly, it is preferred that the external additive is added to the toner surface in a ratio of 0.5 to 3 weight %. Part of the external additive sinks into the interior of the toner particles (coloring resin particles). If trimethylsilanol is adhering to the surface of the external additive that has been buried, it will not evaporate. However, if trimethylsilanol is adhering to the surface of the external additive that is exposed to the air, trimethylsilanol gradually evaporates from the toner, adhering to the discharge electrode of the corona charger. If the volatile amount of trimethylsilanol from the toner exceeds 0.02 μg on the toner weight basis, trimethylsilanol will gradually evaporate and adhere to the discharge electrode of the corona charger, causing charging unevenness. Accordingly, the volatile amount of trimethylsilanol based on the method for quantitative analysis of trimethylsilanol in the toner is preferably specified to be 0.02 μg or below.

The toner can be manufactured by mixing the particulate metal oxide with coloring resin particles (or externally adding the former to the latter) using an airflow mixer such as a Henschel mixer etc. As to the volume mean diameter of the coloring resin particles (toner), the particles that fall within the range of 3 to 15 μm based on the measurement by Coulter counter manufactured by Beckman Coulter, Inc., using a 10 μm aperture can be preferably used.

The coloring resin particles for toner can be manufactured by public known processes such as kneading and pulverizing methods, polymerization methods and the like. As one example, in a kneading and pulverizing method, color resin particles can be manufactured by mixing a binder resin, a coloring agent, a charge control agent, a releasing agent and other additives by a mixer such as a Henschel mixer, super mixer, mechanomill, Q-type mixer or the like, fusing and kneading the resultant raw material mixture at a temperature of about 100 to 180 deg.C. by a kneader such as a biaxial kneader, mono-axial kneader or the like, cooling and solidifying the resultant kneaded product, pulverizing the solidified product by an air pulverizer such as a jet mill or the like and performing grading control such as classifying or the like as required.

As the binder resin used for the toner of the present invention, various publicly known styrene-acrylic resins, polyester resins and others can be listed. In particular, linear or non-linear polyester resin is preferred. Polyester resin is excellent in providing mechanical strength (hard to be broken into powder), fixable performance (hard to separate from paper after fixing) and resistance to hot offset at the same time.

Polyester resin can be obtained by polymerizing diols or higher polyhydric alcohols and polybasic acids, and monomer composition consisting of trihydric or higher polyhydric alcohols or tribasic or higher polybasic acids, as required. Examples of the dihydric alcohol used for polymerization of polyester resin include: diols such as ethylene glycol, diethylene glycol, triethylene glycol, 1,2-propylene glycol, 1,3-propylene glycol, 1,4-butane diol, neopentyl glycol, 1,4-butane diol, 1,5-pentane diol and 1,6-hexane diol; alkylene oxide adducts of bisphenol A such as bisphenol A, hydrogenated bisphenol A, polyoxyethylene bisphenol A, polyoxy propylene bisphenol A and the like; and others.

Example of trihydric or higher polyhydric alcohols include: sorbitol, 1,2,3,6-hexane tetrol, 1,4-solbitane, pentaerythritol, dipentaerythritol, tripentaerythritol, sucrose, 1,2,4-butanetriol, 1,2,5-pentanetriol, glycerol, 2-methyl propanetriol, 2-methyl-1,2,4-butanetriol, trimethylol ethane, trimethylol propane, 1,3,5-trihydroxy methyl benzene and the like.

Examples of dibasic acids include: maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, malonic acid and anhydrides and low alkyl esters of these acids, alkenyl succinic acids and alkyl succinic acids such as n-dodecenyl succinic acid, n-dodecyl succinic acid, etc.

Example of tribasic or higher polybasic acids include: 1,2,4-benzenetricarboxylic acid, 1,2,5-benzene-tricarboxylic acid, 1,2,4-cyclohexanetricarboxylic acid, 2,5,7-naphthalenetricarboxylic acid, 1,2,4-naphthalene-tricarboxylic acid, 1,2,5-hexanetricarboxylic acid, 1, 3-dicarboxyl-2-methyl-2-methylene-carboxypropane, tetra (methylene carboxyl) methane, 1,2,7,8-octane tetracarboxyl acid, and anhydrides of these and the like.

As the coloring agents for the toner of the present invention, publicly known pigments, colorants and the like that are usually used for toner can be used. As the specific examples, carbon black, magnetite and the like can be mentioned for black toner.

Examples of the coloring agent for yellow toner include: acetoacetic arylamide monoazo yellow pigments such as C.I pigments yellow 1, 3, 74, 97, 98 and the like; acetoacetic arylamide disazo yellow pigments such as C.I. pigments yellow 12, 13, 14, 17 and the like; condensed monoazo yellow pigments such as C.I. pigments yellow 93, 155 and the like; other yellow pigments such as C.I. pigments yellow 180, 150, 185 and the like; and yellow dyes such as C.I. solvents yellow 19, 77, 79, C.I. disperse yellow 164, and the like.

Examples of the coloring agent for magenta toner include: C.I. pigments red 48, 49:1, 53:1, 57, 57:1, 81, 122, 5, 146, 184, 238; red or crimson pigments such as C.I. pigment violet 19 and the like; red dyes such as C.I. solvents red 49, 52, 8 and the like.

Examples of the coloring agent for cyan toner include: blue dyes and pigments such copper phthalocyanine and its derivatives such as C.I. pigments blue 15:3, 15:4 and the like; and green pigments such as C.I. pigments green 7, 36 (phthalocyanine green) and the like. The added amount of coloring agent is preferably 1 to 15 parts by weight or more preferably 2 to 10 parts by weight to 100 parts by weight of the binder resin.

As the charge control agents for the toner of the present invention, publicly known charge control agents can used. Specifically, as a charge control agent for providing negative charge, chromium azo complex dye, cobalt azo complex dye, chromium, zinc, aluminum and boron complexes or salts of salicylic acid or its derivatives, chromium, zinc, aluminum and boron complexes or salts of naphtol acid or its derivatives, chromium, zinc, aluminum and boron complexes or salts of benzyl acid or its derivatives, long-chain alkyl carboxylates, long-chain alkyl sulfonates and the like.

As a charge control agent for providing positive charge, nigrosine dye and its derivatives, triphenyl methane derivatives, derivatives of quaternary ammonium salts, quaternary sulfonium slats, quaternary pyridinium salts, guanidine salts, amidine salts and the like.

The added amount of these charge control agents is preferably 0.1 to 20 parts by weight or more preferably 0.5 to 10 parts by weight to 100 parts by weight of the binder resin.

As the releasing agent used for the toner of the present invention, petroleum wax including: synthesized wax such as polypropylene and polyethylene; paraffin wax and its derivatives; and microcrystalline wax and its modified wax, and plant-derived wax including carnauba wax, rice wax and candelilla wax can be listed. Containing these releasing agents in the toner makes it possible to improve the separation performance of the toner from the fusing roller or fusing belt, hence prevent high-temperature and low-temperature offset during fixing. The content of the releasing agent is not particularly limited, but usually, 1 to 5 parts by weight of releasing agent is added to 100 parts of binder resin.

The toner of the present invention can be used as a mono-component developer and can also be used for dual component developers.

Mixing with a carrier can be done by adding 3 to 15 parts by weight of toner to 100 parts by weight of carrier and agitating the mixture by a mixer such as Nauta mixer or the like.

The carrier is not particularly limited, but magnetic particles having a volume mean diameter of 20 to 100 μm can be used. As to the particle size of the carrier, if the carrier is too small, the carrier may transfer from the developing roller to the photoreceptor drum during development, causing white voids in the resultant image. In contrast, if the carrier is too large, dot reproducibility lowers, resulting in coarse images. Accordingly, it is further preferable that the volume mean diameter of the carrier is 30 to 60 μm. The means volume diameter of the carrier is based on the measurement obtained using a laser diffraction particle size analyzer HELOS (Sympatec, Inc.) with a dry disperser RODOS (Sympatec, Inc.) under the condition with a dispersive pressure of 3.0 bar.

As to the saturation magnetization of the carrier, since the lower the saturation magnetization the softer the magnetic brush in contact with the photoreceptor drum becomes, images faithful to electrostatic latent images can be obtained. However, if the saturation magnetization is too low, the carrier tends to adhere to the photoreceptor drum surface, easily causing white voids. In contrast, the saturation magnetization is too high, the magnetic brush becomes rigid so that it is hard to obtain images faithful to electrostatic latent images. Accordingly, the saturation magnetization of the carrier is preferably specified to fall within a range from 30 to 100 emus/g.

As the carrier, coated carriers comprising of a magnetic core particle having a coating layer on the surface thereof have been usually used.

As the core particle, publicly known magnetic particles can be used, but ferrite particles are preferable in view of static charge performance and durability. As the ferrite particle, publicly known products can be used. For example, zinc ferrite, nickel ferrite, copper ferrite, nickel zinc ferrite, manganese magnesium ferrite, copper magnesium ferrite, manganese zinc ferrite, manganese copper zinc ferrite and the like can be listed.

These ferrite particles can be manufactured by publicly known methods. For example, ferrite raw materials such as Fe₂O₃, Mg(OH)₂ and the like are blended and the mixed powder is prebaked in a heating furnace. The resultant prebaked product is cooled and pulverized by a vibration mill into particles having a size of about 1 μm, then a dispersing agent and water is added to the pulverized powder to prepare slurry. This slurry is wet pulverized by a wet ball mill, and the resultant suspension is granulated and dried to thereby obtain the ferrite particles.

As the coating material, publicly known resin materials can be used. For example, acrylic resin, silicone resin and others can be used. In particular, a coated carrier having a silicone resin coating thereon is preferable since boron compounds are hard to adhere to its surface and it can maintain the capability of electrifying the toner over a prolonged period of time.

As the silicone resin, publicly known products can be used. Examples include: silicone varnishes (trade name: TSR115, TSR114, TSR102, TSR103, YR3061, TSR110, TSR116, TSR117, TSR108, TSR109, TSR180, TSR181, TSR187, TSR144 and TSR165, all products of Shin-Etsu Chemical Co., Ltd.; and KR271, KR272, KR275, KR280, KR282, KR267, KR269, KR211 and KR212, all products of TOSHIBA CORPORATION); alkyd-modified silicone varnishes (trade name: TSR184 and TSR185, all products of TOSHIBA CORPORATION); epoxy-modified silicone varnishes (trade name: TSR194 and YS54, all products of TOSHIBA CORPORATION); a polyester-modified silicone varnish (trade name: TSR187, a product of TOSHIBA CORPORATION); acryl-modified silicone varnishes (trade name: TSR170 and TSR171, all products of TOSHIBA CORPORATION), urethane-modified silicone varnish (trade name: TSR175, a products of TOSHIBA CORPORATION); and reactive silicone resins (trade name: KA1008, KBE1003, KBC1003, KBM303, KBM403, KBM503, KBM602 and KBM603, all products of Shin-Etsu Chemical Co., Ltd.).

In order to control the volume resistivity of the carrier, conductive material is added to the coating material. Examples of the conductive material include silicon oxide, alumina, carbon black, graphite, zinc oxide, titanium black, iron oxide, titanium oxide, tin oxide, potassium titanate, calcium titanate, aluminum borate, magnesium oxide, barium sulfate, calcium carbonate and others.

Of these conductive materials, carbon black is preferable in view of manufacturing stability, cost and low electric resistance. The type of carbon black is not particularly limited, but a carbon black having a DBP (dibutylphthalate) oil absorption of 90 to 170 ml/100 g is preferable since it shows manufacturing stability. Further, carbon black having a primary diameter of 50 nm or below is particularly preferable since it is excellent in dispersibility. A single kind of conductive material may be used, or two or more kinds of conductive materials may be used in combination. As to the usage amount of conductive material, 0.1 to 20 parts by weight of conductive material may be used for 100 parts by weight of coating material.

Coating the carrier particles with a coating material can be done by publicly known methods. Examples includes: an immersing process of immersing carrier particles into an organic solvent solution of a coating material; a spraying process of spraying an organic solvent solution of a coating material to carrier particles; a fluidized bed process of spraying an organic solvent solution of a coating material with the carrier particles floated by fluidized air; and a kneader-coater process of mixing carrier particles and an organic solvent solution of a coating material in a kneader-coater and removing the solvent. In the above processes, in the organic solvent solution of the coating material, conductive material for controlling resistivity is added together with the coating material.

Next, the image forming apparatus of the present invention will be described with reference to the drawings.

As shown in FIG. 1, an image forming apparatus 1 is a digital copier having copy and print modes, which, in the copy mode, prints out duplications in accordance with image information of originals that are read by an aftermentioned scanner portion 29 and in the print mode, prints out images in accordance with image information that is transferred from external devices connected to image forming apparatus 1 via a network. Image forming apparatus 1 includes a photoreceptor drum 20, corona charger 21, exposure device 22, developing unit 10, transfer device 23, fuser unit 25, cleaning unit 24, paper feed tray 28 and scanner portion 29 and paper output tray 30.

FIG. 2 is a sectional view schematically showing a configuration of a developing unit and photoreceptor drum. Developing unit 10 includes a developing vessel 2, developing roller 3, first agitator 4, second agitator 5, conveyor 6, regulatory member 7, regulatory member support 8, flow guide plate 9, magnetic member 10, magnetic member support 11 and toner concentration detecting sensor 12.

Developing vessel 2 is a container of an approximately prism-like configuration having an interior space for holding developer, in which developing roller 3, first agitator 4, second agitator 2 and conveyor 6 are rotatably supported while regulatory member 7, flow guide plate 9 and others are directly or indirectly supported. The developer is a dual-component developer made up of a toner and carrier of a magnetic powder. Developing vessel 2 is formed with an opening 2a on one side that opposes photoreceptor drum 20 arranged in an unillustrated electrophotographic image forming apparatus when developing unit 10 is mounted to the image forming apparatus. Developing vessel 2 also has a toner supply port 2b formed on the top surface with respect to the vertical direction.

An unillustrated toner cartridge and toper hopper are arranged vertically above developing vessel 2. More detailedly, the toner cartridge, toner hopper and developing vessel 2 are arranged vertically from top to bottom in the order mentioned. The toner cartridge holds toner in its interior space and is detachably arranged relative to the unillustrated image forming apparatus body to which developing unit 10 is attached.

The toner cartridge is rotationally driven about its axis by an unillustrated means provided for the image forming apparatus. Formed on the longitudinal side of the toner cartridge is a narrow elongate opening that extends longitudinally. This elongate opening allows the toner to drop and be supplied into the toner hopper as the toner cartridge rotates.

The toner hopper is arranged so that, for example its toner feed port as an opening formed in the bottom with respect to the vertical direction communicates with toner supply port 2b as the opening formed on the top, with respect to the vertical direction, of developing vessel 2. A toner supply roller 19 is arranged vertically above the toner feed port, inside the toner hopper. Toner supply roller 19 is rotatably supported by the toner hopper and rotationally driven by an unillustrated means. Rotational drive of toner supply roller 19 is controlled in accordance with the detected result of the toner concentration detected by toner concentration detecting sensor 12, by an unillustrated control means provided for the image forming apparatus. As toner supply roller 19 is driven rotationally, toner is supplied into developing vessel 2 through the toner feed port and toner supply port 2b.

Developing roller 3 is a roller-shaped member that is at least partially supported by developing vessel 2 so as to be rotatable and rotationally driven about its axis by an unillustrated drive means. Developing roller 3 is arranged opposing photoreceptor drum 20 through opening 2a of developing vessel 2. Developing roller 3 is disposed a predetermined gap apart from photoreceptor drum 20, forming a developing nip portion in the closest area. The toner is supplied from the unillustrated developer layer on the developing roller 3 surface to the electrostatic latent image on the photoreceptor drum 20 surface in the developing nip portion. In the developing nip portion, a developing bias voltage is applied to developing roller 3 by an unillustrated power supply connected to developing roller 3 so that the toner can smoothly transfer from the developer layer on the developing roller 3 surface to the electrostatic latent image on the photoreceptor drum 20 surface. In the present embodiment, a sleeve 14 rotates counterclockwise while photoreceptor drum 20 rotates clockwise. First agitator 4 and second agitator 5 are both a roller-shaped member that is supported rotatably by developing vessel 2 and rotationally driven about the axis by an unillustrated drive means. In the present embodiment, first agitator 4 rotates counterclockwise and second agitator 5 rotates clockwise. First agitator 4 is arranged at a position on the opposite side across developing roller 3 from that of photoreceptor drum 20 and below developing roller 3. In the present embodiment, the angle formed between the radius S2 and the line joining the axis of developing roller 3 and the axis of first agitator 4, or the mounted angle of first agitator 4 is set at 54 degrees. Second agitator 5 is arranged at a position on the opposite side across first agitator 4 from that of developing roller 3 and below developing roller 3. First agitator 4 and second agitator 5 agitate the developer stored in developing vessel 2 so as to produce uniform charge on the toner and scoop and convey the tribo-electrified developer toward and around developing roller 3.

Conveyor 6 is a roller-shaped member that is rotatably supported by developing vessel 2 and can be rotationally driven by an unillustrated drive means. Conveyor 6 is arranged at a position on the opposite side across second agitator 5 from that of first agitator 4 and vertically under toner supply port 2b. Conveyor 6 conveys the toner that is supplied from toner supply port 2b into developing vessel 2 toward and around second agitator 5.

Regulatory member 7 is a plate-like member that extends parallel to the axis of developing roller 3 and is supported along one long edge thereof on one side with respect to the width thereof by developing vessel 2 and regulatory member support 8 over and above developing roller 3 so that the long edge on the other side is arranged a predetermined gap apart from the developing roller 3 surface. In the present embodiment, regulatory member 7 is positioned in the radial direction of developing roller 3 (on the extension of the radius of developing roller 3) so that the angle formed between the extension and the radius N1 that passes through the position where a magnetic pole N1 is arranged on the section of developing roller 3 is 90 degrees. Regulatory member 7 is formed of elastic non-magnetic metal such as stainless steel, aluminum, synthetic resin or the like. In the present embodiment, regulatory member 7 is formed of a thin plate of stainless steel. Regulatory member support 8 supports regulator member 7 in cooperation with developing vessel 2. Specifically, regulatory member 7 is supported by holding its long edge and therearound on one side with respect to its width on one short side between regulatory member support 8 and developing vessel 2. Regulatory member support 8 is formed of, for example, synthetic resin, metal or the like. In the present embodiment, this support is formed of synthetic resin. Regulator member 7 keeps the layer thickness of the developer layer constant by removing surplus developer from the developer layer carried on the developing roller 3 surface to thereby regulate the amount of conveyance of the developer. Regulatory member 7 rubs the developer layer with its long edge on the other short side to produce electric charge on the developer that has poor static charge in the developer layer so as to electrify the developer in the developer layer adequately.

In developing unit 10, the developer stored in developing vessel 2 is conveyed vertically upward over first agitator 4 by rotation of first agitator 4 and second agitator 5 and raised by magnetic member 10 to be supplied to the developing roller 3 surface. Developing roller 3 rotates carrying the developer layer on the surface thereof so as to electrify the developer thereon and regulate the developer layer as to its thickness by regulatory member 7, then supplies the toner to the electrostatic latent image on photoreceptor drum 20 to develop it.

After development, developing roller 3 further rotates and receives a supply of developer again. On the other hand, the developer removed off the developing roller 3 surface by regulatory member 7 flows over and along the top surface of flow guide plate 9 in the direction away from developing roller 3 to be returned to the area between second agitator 5 and conveyor 6, where the flow of developer meets the other flow of developer to be mixed again then conveyed toward developing roller 3. Thus, the developer is circulated as above in developing vessel 2. Conveyor 6 conveys the toner that is supplied into developing vessel 2 in accordance with the detected result by toner concentration detecting sensor 12, to second agitator 5 and therearound.

Photoreceptor drum 20 is a roller-shaped member that is axially supported so as to be rotatably driven by an unillustrated drive means and has a photoconductive coating on which an electrostatic latent image and hence a toner image is formed. For example, photoreceptor drum 20 may use a roller-shaped member made of an unillustrated conductive base and an unillustrated photoconductive coating formed on the conductive base surface. The conductive base may use a conductive base of a hollowed cylinder, a solid cylinder or a sheet-like form. Of these, a hollowed cylindrical conductive base is preferable. As the photoconductive coating, an organic photoconductive coating, an inorganic photoconductive coating and the like may be employed.

The organic photoconductive coating may be given as a lamination-type photoreceptor drum in which a charge generating layer of a resin coating containing a charge generating substance and a charge transport layer of a resin coating containing a charge transport substance are laminated or may be given as a mono-layered photoreceptor drum in which a single resin coating that contains both a charge generating substance and a charge transport substance is formed. The inorganic photoconductive coating may be given as a film coating containing one or two or more kinds of substances selected from zinc oxide, selenium, amorphous silicon and the like. A primer coating may be inserted between the conductive base and the photoconductive coating. A surface coating (protective coating) for principally protecting the photoconductive coating can be formed on the surface of the photoconductive coating.

Corona charger 21 electrifies the photoreceptor drum 20 surface at a predetermined potential of a designated polarity by corona discharge. As corona charger 21, a saw-toothed charger having a saw-toothed discharge electrode, a scorotron charger having tungsten wire or the like can be used.

FIG. 3 is an exploded perspective view showing a configuration of a saw-toothed charger 21a as one embodied mode of a corona charger.

Saw-toothed charger 21a comprises a conductive shield case 31, saw-toothed electrode 32, grid electrode 33 and insulative electrode holder 34 for holding these electrodes. Shield case 31 is a conductive shield plate having a length approximately equal to the width of photoreceptor drum 20 (the dimension in the direction of the rotational axis of the drum) and is open on the side that opposes the photoreceptor drum 20 surface. Saw-toothed electrode 32 is formed of a strip-like thin plate of stainless steel (iron-based alloys containing chromium and nickel, represented by SUS 304 in JIS standard) having a plurality of pointed projections for discharge, arranged in a row at intervals of a predetermined distance (2 mm). This saw-toothed electrode 32 can be formed by an etching process.

This saw-toothed electrode 32 is formed with a plurality of holes for fixture. These holes are fitted on projections 34b that are integrally formed on a flat surface portion 34a of electrode holder 34 made of insulative material. With this configuration, saw-toothed electrode 32 is positioned (fixed) to flat portion 34a of electrode holder 34 in such a manner that it is electrically insulated from shield case 31.

Electrode holder 34 is further formed at both ends with a pair of integrated grid electrode supports 35 for supporting grid electrode 33 so as to keep it electrically insulated from shield case 31 and saw-toothed electrode 32. Each of grid electrode supports 35 has engaging portions 35a with engaging hooks, formed corresponding to holes 33a arranged at both ends of grid electrode 33. To attach grid electrode 33, engaging portions 35a are fitted through corresponding holes 33a of grid electrode 33 by elastically deforming these grid electrode supports 35, then they regain their original geometry by releasing the stress so that grid electrode 33 can be supported with a predetermined tensile force by its elastic force.

The aforementioned grid electrode 33 is formed with uniformly distributed mesh-like holes by etching a stainless strip-like thin plate in the same manner as in the case of the aforementioned saw-toothed electrode 32. Grid electrode supports 35, integrally formed with electrode holder 34, are elastically deformed so as to be inserted into the holes of grid electrode 33 and engaged therein to thereby tension the grid electrode with the elastic force.

Here, a pair of positioning supporters 36 are formed integrally with electrode holder 34 at positions corresponding to both ends of shield case 31 so as to position electrode holder 34 inside shield case 31.

In assembly of the corona charger thus constructed, saw-toothed electrode 32 is set and held on electrode holder 34 by fitting its holes onto the projections of flat portion 34a of electrode holder 34, then the electrode holder 34 with saw-toothed electrode 32 held thereon is accommodated inside shield case 31 at the predetermined position that is positioned by positioning supporters 36 at both ends of shield case 31. Then, grid electrode 33 is engaged by inserting engaging portions 35a of grid electrode supports 35 into holes 33a of grid electrode 33. Here, a spring terminal 37 is an elastic terminal for providing power supply to saw-toothed electrode 32 through its elastic electric connection to the end of saw-toothed electrode 32 that is positioned to holder 34 and projected from the shield case.

FIG. 4 is a block diagram showing one example of a power supply circuit including a high-voltage circuit for supplying voltage to saw-toothed electrode 21a. As shown in FIG. 4, predetermined voltages are applied to the electrodes and shield case of corona charger 21 by the power supply circuit.

In FIG. 4, a predetermined voltage of +24V is supplied to a power supply circuit 40. Power supply circuit 40 incorporates a high-voltage generating circuit 41 for converting the supplied voltage, i.e., +24V into predetermined voltages to be output. This high-voltage generating circuit 41 generates voltage to be supplied to shield case 31, saw-toothed electrode 32 and grid electrode 33 of coronal charger 21 of the present invention. The generated voltage is output as the predetermined voltages from associated output terminals. Though detailed later, power supply circuit 40 further includes a voltage control circuit 42 for controlling the voltage generated from high-voltage generating circuit 41 when the voltage is supplied to shield case 31 and saw-toothed electrode 32 of corona charger 21.

Saw-toothed electrode 32 in corona charger 21 is connected to an output terminal MC in power supply circuit 40 so as to have a high voltage V supplied thereto. Shield case 31 is connected to an output terminal CASE in power supply circuit 40 so as to have a high voltage Vc supplied thereto. Further, grid electrode 33 is connected to an output terminal GRID from voltage control circuit 42 so as to have a high voltage Vg supplied thereto. The above voltage control circuit 42 includes a variable resistor VR1 for adjusting the output voltage from output terminal CASE to be supplied to shield case 31 and a variable resistor VR2 for adjusting the output voltage from output terminal GRID to be supplied to grid electrode 33.

When corona charger 21 receives the necessary voltages from the thus constructed power supply circuit 40, corona discharge occurs from the pointed projections of saw-toothed electrode 32. As a result, the whole current (total current It) for the corona discharge flows through saw-toothed electrode 32. In this case, grid current Ig flowing through grid electrode 33 can be adjusted by setting the voltage output from output terminal GRID as appropriate through variable resistor VR2 of control circuit 42. Similarly, case current Ic that flows through shield case 31 as the corona discharge occurs, can be adjusted by controlling the supplied voltage through variable resistor VR1.

The current It that flows as a result of corona discharge when high voltage is applied to saw-toothed electrode 21 is equal to the sum of case current Ic and grid current Ig that flow through the aforementioned shield case 31 and grid electrode 33, respectively. More explicitly, the current (total current) It flowing through saw-toothed electrode 21 as a result of corona discharge split, flowing through shield case 31 and grid electrode 33. Total current It is split into case current Ic and grid current Ig, hence can be expressed as the following Eq. (1):

It=Ic+Ig Eq. (1).

Since it is possible to make the current flowing through saw-toothed electrode 21 constant by keeping total current It constant, constant-current control is performed in high-voltage generating circuit 41 of power supply circuit 40 using a constant-current controller.

As the exposure device 22, a laser scanning system including a light source is used. The laser scanning system is a unit that includes, for example a light source, polygon mirror, f-θ lens, reflection mirrors and other elements. As the light source, a semiconductor laser, LED array, electroluminescence (EL) device and the like can be used. Exposure device 22 receives input of image information of originals read by scanner portion 29 or input of image information from an external device and illuminates the electrostatically electrified photoreceptor drum 20 surface with signal light corresponding to the image information. In this way, an electrostatic latent image corresponding to the image information is formed on the photoreceptor drum 20 surface.

Transfer device 23 is a roller-shaped member that is arranged in pressure contact with photoreceptor drum 20 and supported rotatably by an unillustrated supporting structure so as to be rotationally driven by an unillustrated drive means. As transfer device 23, a roller-shaped member formed of a metal core having a diameter of, for example 8 to 10 mm and an elastic conductive layer formed on the surface of the metal core is used. As the metal forming the metal core, stainless steel, aluminum or the like may be used. As the elastic conductive layer, rubber material, such as ethylene-propylene rubber (EPDM), foamed EPDM, foamed urethane, etc., in which a conductive substance such as carbon black etc. is blended can be used. Recording mediums are fed, sheet by sheet, from paper feed tray 28 by an unillustrated pickup roller and registration roller into the pressure contact portion (transfer nip portion) between photoreceptor drum 20 and transfer device 23 in synchronization with the toner image conveyed by rotation of photoreceptor drum 20.

As the recording medium passes through the transfer nip portion, the toner image on the photoreceptor drum 20 surface is transferred to the recording medium. An unillustrated power supply is connected to transfer device 23 so as to apply a voltage of an opposite polarity to that of static charge on the toner constituting the toner image, to transfer device 23 when the toner image is transferred to the recording medium. Thus, the toner image is smoothly transferred to the recording medium. In this transfer device 23, the toner image on the photoreceptor drum 20 surface is transferred to a recording medium.

Cleaning unit 24 includes an unillustrated cleaning blade and an unillustrated toner storing vessel. The cleaning blade is a plate-like member that extends parallel to the length of photoreceptor drum 20 and is arranged to abut its long edge on one short side against the photoreceptor drum 20 surface. This cleaning blade removes toner, paper particles and the like that have been left over on the photoreceptor drum 20 surface after transfer of the toner image to the recording medium, from the photoreceptor drum 20 surface. The toner storing vessel is a container-like member having a hollow space therein and temporarily stores the toner removed off by the cleaning blade. Cleaning unit 24 cleans the photoreceptor drum 20 surface after transfer of toner image.

Fuser unit 25 includes a fusing roller 26 and pressure roller 27. Fusing roller 26 is a roller-shaped member that is rotatably supported by an unillustrated structure and can be axially rotated by an unillustrated drive means. Fuser roller 26 has an unillustrated heater therein to heat and fuse the toner constituting the unfixed toner image carried on the recording medium being conveyed from the transfer nip portion, to thereby fix the image to the recording medium. As fusing roller 26, a roller-shaped member formed of a metal core and an elastic layer is used. The metal core is formed of metal such as iron, stainless steel, aluminum or the like. The elastic layer is formed of an elastic material such as silicone rubber, fluororubber, etc. The heater generates heat as it is supplied with a voltage from an unillustrated power supply. The heater may use a halogen lamp, infrared lamp and the like.

Pressure roller 27 is a roller-shaped member that is rotatably supported and pressed against fusing roller 26 by an unillustrated pressing member. Pressure roller 27 is driven to rotate as fusing roller 26 rotates. The pressure contact portion between fusing roller 26 and pressure roller 27 form the fixing nip portion. Pressure roller 27 assists the fixing of the toner image to the recording medium by pressing the melting toner to the recording medium when the toner is heated and fixed to the recording medium by fusing roller 26. Pressure roller 27 may use a roller-shaped member having the same configuration as fusing roller 26. Pressure roller 27 may also include a heating element therein. As the heating element the same heating element as in fusing roller 26 may be used.

According to fuser unit 25, the recording medium with a toner image transferred thereon is passed through the fixing nip portion so as to fuse the toner forming the toner image and press it to the recording medium, to thereby fix the toner image to the recording medium and complete an image printout. The recording medium with an image printed thereon is conveyed by an unillustrated conveying means, discharged and stacked onto paper output tray 30 which is arranged on one vertical side of image forming apparatus 1.

Paper feed tray 28 is a tray for holding recording media such as plain paper, coated paper, color copy paper, OHP film sheets and the like. A plurality of paper feed trays 28 may be provided so that each tray holds recording media of a different size from the others. Examples of the size of recording media include A3, A4, B5, B4, etc. A plurality of paper feed trays 28 may hold recording medium of an identical size. An unillustrated pickup roller, conveying rollers and registration roller feed recording media, sheet by sheet, to the transfer nip portion in synchronization with conveyance of the toner image on the photoreceptor drum 20 surface.

Scanner portion 29 is equipped with an unillustrated document set tray, a reversing automatic document feeder (RADF) and the like and also includes an unillustrated document reading device.

The automatic document feeder feeds originals stacked on the document set tray to the original table of the document reading device. The document reading device includes the original table, a document scanner, reflecting components and a line sensor of a photoelectric transducer (charge coupled device, which will be referred to hereinbelow as ‘CCD’) to read the image information of the original placed on the original table every multiple lines, for example, every ten lines. The original table is formed of a glass plate member on which an original is placed to read image information therefrom. Document scanner includes an unillustrated light source and a first reflecting mirror, moving along, and parallel to, the underside of the original table at a fixed speed V in a reciprocating manner so as to illuminate the image surface of the document placed on the original table with light. A reflected light image can be obtained by this light illumination. The light source is a light emitter for emitting light over the original placed on the original table. The first reflecting mirror reflects the reflected light image to a reflecting assembly. This reflecting assembly includes unillustrated second and third reflecting mirrors and an optical lens to focus the reflected light image obtained by the document scanner on to the CCD line sensor. The reflecting assembly reciprocates at a speed of V/2 following the reciprocating movement of the document scanner. The second and third reflecting mirrors reflect the reflected light image toward the optical lens. The optical lens focuses the reflected light image onto the CCD line sensor. The CCD line sensor includes an unillustrated CCD circuit for photoelectrically converting the reflected light image focused by the optical lens into electric signals and outputs the electric signals carrying the image information to the image processor in the control means. The image processor converts the image information supplied from the document reading device or an external device such as a personal computer or the like into electric signals, which are output to exposure device 22.

As has been described above, in the image forming apparatus of the present invention, since use of the toner specified as above makes it possible to prevent adherence of pollutant to the discharge electrode of the corona charger, hence prevent uniform discharge from being disturbed, charging unevenness as a result of uneven discharge is unlikely to occur, so that it is possible to obtain stable images free from black stripes over a long period of time. Further, a saw-toothed charger which produces a lower amount of ozone gas is environmentally friendly, but because its discharge electrode has pointed projections, impurities are prone to build up at the pointed tips, easily causing charging unevenness. In the image forming apparatus of the present invention, it is possible not only to suppress generation of ozone but also obtain stable images free from black stripes over a prolonged period of time.

### EXAMPLE

External toner additives of metal oxide particulates for examples and a comparative example were obtained or manufactured in the following manner.

### <External Toner Additive>

1. As a particulate metal oxide that has been surface treated with hexamethyldisilazane, 100 g of a hydrophobic particulate silica having a number mean diameter of 12 nm (trade name: R8200) manufactured by AEROSIL Co. Ltd., was charged into an airflow mixer (Henschel mixer, manufactured by MITSUI MINING CO., LTD) having an air inlet port and air outlet port and agitated by an agitating rotor rotating at a peripheral speed of 5 m/sec while air at 150 deg.C. was blown in from the air inlet port. Trimethylsilanol was evaporated and removed from the surface of the hydrophobic particulate silica by blowing air at a supply rate of 0.1 m³ per minute for 30 minutes to prepare an external toner additive G_b 1.

2. An external toner additive G2 was prepared in the same manner as that for external toner additive G1 except in that the temperature of blown air was 120 deg.C. and the time for air blowing was 60 minutes.

3. An external toner additive G3 was prepared in the same manner as that for external toner additive G2 except in that the time for air blowing was 30 minutes.

4. An external toner additive G4 was prepared in the same manner as that for external toner additive G3 except in that the temperature of blown air was 60 deg.C.

5. As a comparative sample (external toner additive G5), a hydrophobic particulate silica (trade name: R8200) manufactured by AEROSIL Co. Ltd., was used without hot air blowing.

The volatile amount of trimethylsilanol for each external toner additive was measured based on the above-described method measuring trimethylsilanol of the external additive. The result is shown in Table 1.

TABLE 1

| External additive | | Trimethylsilanol |
|---|---|---|
| (particulate metal | Conditions for hot | Volatile amount |
| oxide) | air blowing | (μg) |
| G1 | 150 deg. C. for 30 min | 0.09 |
| G2 | 120 deg. C. for 60 min | 0.15 |
| G3 | 120 deg. C. for 30 min | 0.25 |
| G4 | 60 deg. C. for 30 min | 0.48 |
| G5 | None | 1.8 |

As shown in Table 1, it was confirmed that the volatile amount of trimethylsilanol decreases by a hot air blowing process.

The toner (coloring resin particulates) in the examples and comparative example were prepared using the materials as follows.

### <Coloring Resin Particle>

A hundred parts by weight of a binder resin (a polyester resin that is obtained by performing a polycondensation reaction of bisphenol A polypropylene oxide, terephthalic acid and trimellitic anhydride as monomer units: the glass transfer temperature is 60 deg.C.; the softening temperature is 130 deg.C.), 6 parts by weight of carbon black (MA-100: a product of MITSUBISHI CHEMICAL CORPORATION), 2 parts by weight of charge control agent (LR-147: a product of Japan Carit Co., Ltd.) and 2 parts by weight of polypropylene wax (VISCOL 550P: a product of Sanyo Chemical Industries, Ltd.) were mixed for 10 minutes by an air-flow mixer (Henschel mixer, a product of MITSUI MINING CO., LTD). The mixture was fused and kneaded by a kneading and dispersing processor (KNEADEX MOS140-800: a product of MITSUI MINING CO., LTD). The kneaded product was cooled then crushed by a cutting mill. The crush was pulverized by a pulverizer (GCS: a product of MITSUI MINING CO., LTD) and classified using an air classifier (TSP separator: a product of Hosokawa Micron Corporation) to prepare a coloring resin particulate having a volume mean diameter of 6.5 μm with a BET specific surface area of 1.8 m²/g.

Here, the volume mean diameter was measured by Coulter Multisizer II (manufactured by Beckman Coulter, Inc.).

### <Toner>

Toner T1 was prepared by externally adding 2% by weight of the aforementioned external toner additive G1 on the toner weight basis into the aforementioned coloring resin particle. External addition was carried out by loading the coloring resin particle and the external additive into an air-flow mixer (Henschel mixer, a product of MITSUI MINING CO., LTD) and mixing them for two minutes with the tip speed of the agitating rotor set at 15 m/sec.

Toners T2 to T5 were prepared in the same manner as that of toner T1 except the associated external additive was used instead of external additive G1.

Table 2 shows the toners and the volatile amount of trimethylsilanol from the toners measured based on the above-described method of measuring trimethylsilanol of the toner.

TABLE 2

| | External | Added amount of | | |
|---|---|---|---|---|
| | additive | external | Trimethylsilanol | Black |
| | (particulate | additive | Volatile amount | stripes in |
| Toner | metal oxide) | (weight %) | (μg) | image |
| T1 | G1 | 2 | 0.01 | None |
| T2 | G2 | 2 | 0.01 | None |
| T3 | G3 | 2 | 0.02 | None |
| T4 | G4 | 2 | 0.04 | Slightly |
| | | | | observed |
| T5 | G5 | 2 | 0.12 | Observed |

### <Dual Component Developer>

The above toners (T1 to T5) were each blended with a carrier to prepare dual component developers. The mixing of dual component developer was carried out by loading 6 parts by weight of the toner and 94 parts by weight of the carrier into a Nauta mixer (trade name: VL-0, manufactured by Hosokawa Micron Corporation) and agitating the mixture for 20 minutes to prepare the dual component developer.

### <Carrier>

The carrier used in the examples and comparative example was prepared by the following process. Ferrite compounds were mixed by a ball mill first, then prebaked by a rotary kiln at 900 deg.C. The resultant prebaked powder was pulverized using steel balls as a pulverizing medium into particles having a mean diameter of 2 μm or below. The obtained ferrite particulate was granulated by spray drying and the resultant granulated particles were baked at 1300 deg.C. After baking, the resultant product was crushed by a crusher to obtain core particles of a ferrite composition having a volume mean diameter of about 50 μm with a volume resistivity of 1×10⁹ Ω·cm.

Next, for a coating liquid for covering the core particles, a silicone resin (trade name: TSR115 manufactured by Shin-Etsu Chemical Co., Ltd. ) was dissolved and dispersed into toluene to prepare a coating liquid. Five parts by weight of this coating liquid (on the silicone resin basis) was sprayed to 100 parts by weight of the core particles by a spray coater to coat the core particles. After completely removing toluene by evaporation, a carrier C1 having a volume mean diameter of 50 μm having a silicone resin coating of 1 mm thick with a saturation magnetization of 65/g was prepared.

### <Image Evaluation>

A continuous print running test of 50 K sheets was carried out in the image forming apparatus for testing, shown in FIG. 1, using each of the prepared toners T1 to T5 for dual component developer. The conditions for development in the image forming apparatus were adjusted with the peripheral speed of the photoreceptor set at 400 mm/sec, the peripheral speed of the developing roller set at 560 mm/sec, the gap between the photoreceptor and the developing roller set at 0.42 mm, the gap between the developing roller and the regulatory blade set at 0.5 mm. Further, the surface potential of the photoreceptor and the developing bias were adjusted so that the amount of toner adherence on the paper for a solid image (100% density) was equal to 0.5 mg/cm² and the amount of toner adherence for non-image area could be minimized. As the print test paper, A4 size electrophotography paper (Multi-Receiver, manufactured by SHARP DOCUMENT SYSTEMS CORPORATION) was used. A text image to be printed on the paper with 6 percent paper coverage was used as the image for printing.

As shown in Table 2 above, no black stripe occurred for all the 50 K sheets of images in the 50 K continuous print tests using toners T1 to T3.

FIG. 5 is a photograph of the discharge electrode of the corona charger (saw-toothed charger) after printing of 50 K sheets that was taken by using a scanning electron microscope (SEM). As seen from this picture no buildup was observed at the pointed ends. In the 50 K continuous print test using toner T4, slight occurrence of black stripes was observed in the image after printing of 50 K sheets. In the 50 K continuous print test using toner T5, distinct occurrence of black stripes was observed in the image after printing of 50 K sheets.

FIG. 6 is a SEM photograph of the discharge electrode of the corona charger that was taken at that time. Radial buildups were observed at the pointed ends. As to the impurities deposited on the pointed ends, distinct element peaks corresponding to Si and O were detected by SEM-EDX analysis.

The external toner additive of the present invention is an external additive that can suppress adherence of impurities to the discharge electrode of the corona charger, hence can prevent occurrence of charging unevenness. The toner using this external toner additive and the image forming apparatus using the toner provide a high level of industrial applicability.

What is claimed is:

1) An external toner additive comprising a particulate metal oxide with trimethylsilyl groups introduced on the surface thereof, the volatile amount of trimethylsilanol being specified to be 0.25 μg or below based on a method for quantitative analysis of trimethylsilanol in the external additive.

2) A toner comprising:
coloring resin particles; and
an external additive adhered to the coloring resin particles, the external additive being formed of a particulate metal oxide with trimethylsilyl groups introduced on the surface thereof, the volatile amount of trimethylsilanol being specified to be 0.25 μg or below based on a method for quantitative analysis of trimethylsilanol in the external additive,
characterized in that the volatile amount of trimethylsilanol is specified to be 0.02 μg or below based on a method for quantitative analysis of trimethylsilanol in the toner.

3) The toner according to claim 2, wherein the number mean diameter of the external additive ranges from 7 nm to 30 nm and the content of the external additive in the toner ranges from 0.5% by weight to 3% by weight.

4) The toner according to claim 2, wherein the metal oxide is a particulate silica having trimethylsilyl groups introduced on the surface thereof.

5) The toner according to claim 3, wherein the particulate metal oxide is a particulate silica having trimethylsilyl groups introduced on the surface thereof by hexamethyldisilazane.

6) The toner according to claim 5, wherein the particulate silica is obtained by blowing hot dry air at a temperature of 110 deg.C. to 150 deg.C. for 30 or more minutes to the particulate silica that has trimethylsilyl groups introduced on the surface thereof by hexamethyldisilazane, at a rate of 0.1 m³ per minute for 100 g of the particulate silica.

7) The toner according to claim 3, wherein the metal oxide is a particulate silica having trimethylsilyl groups introduced on the surface thereof.

8) The toner according to claim 7, wherein the particulate metal oxide is a particulate silica having trimethylsilyl groups introduced on the surface thereof by hexamethyldisilazane.

9) The toner according to claim 8, wherein the particulate silica is obtained by blowing hot dry air at a temperature of 110 deg.C. to 150 deg.C. for 30 or more minutes to the particulate silica that has trimethylsilyl groups introduced on the surface thereof by hexamethyldisilazane, at a rate of 0.1 m³ per minute for 100 g of the particulate silica.

10) An image forming apparatus for forming images based on an electrophotographic process, comprising:
a photoreceptor drum for forming an electrostatic latent image on the surface thereof;
a corona charger for electrifying the photoreceptor drum surface;
an exposure device for forming an electrostatic latent image on the photoreceptor drum surface;
a developing unit for holding toner and supplying the toner to the electrostatic latent image on the photoreceptor drum surface to form a toner image;
a transfer device for transferring the toner image on the photoreceptor drum surface to a recording medium;
a cleaning unit for cleaning the photoreceptor drum surface; and,
a fuser device for fixing the toner image to the recording medium,
characterized in that the image forming apparatus uses a toner comprising: coloring resin particles; and an external additive adhered to the color resin particles, the external additive being formed of a particulate metal oxide with trimethylsilyl groups introduced on the surface thereof, being specified such that the volatile amount of trimethylsilanol is 0.25 μg or below based on a method for quantitative analysis of trimethylsilanol in the external additive and the volatile amount of trimethylsilanol is 0.02 μg or below based on a method for quantitative analysis of trimethylsilanol in the toner.

11) The image forming apparatus according to claim 10, wherein the corona charger is a saw-toothed charger.
